(19) United States
(12) Patent Application Publication
(10) Pub. No.: US 2010/0116151 A1
(43) Pub. Date: May 13, 2010

(54) TREATMENT OF FOOD MUST WITH LOW ENERGY, SHORT PULSED ELECTRIC FIELD

(75) Inventors: Dan Singleton, El Segundo, CA (US); Jason Sanders, Los Angeles, CA (US); Martin Gundersen, San Gabriel, CA (US)

Correspondence Address: MCDERMOTT WILL & EMERY LLP, 2049 CENTURY PARK EAST, 38th Floor, LOS ANGELES, CA, 90067-3208, US

(73) Assignee: UNIVERSITY OF SOUTHERN CALIFORNIA, Los Angeles, CA (US)

(21) Appl. No.: 12/607,844

(22) Filed: Oct. 28, 2009

Related U.S. Application Data
(60) Provisional application No. 61/112,504, filed on Nov. 7, 2008.

(51) Int. Cl. A23L 3/32

(52) U.S. Cl. 99/451

(57) ABSTRACT

An apparatus for treating food must, such as grape must, may include a food must chamber configured to apply an electric pulse to the food must in a manner that causes an electric field to be generated within the food must. A pulse generator may be configured to deliver an electric pulse to the chamber that has a pulse width of between 10 and 100 nanoseconds. The chamber and the pulse generator may be configured such that they cause the electric field that is generated within the food must to be at least 1 kV/cm.

### CROSS-REFERENCE TO RELATED APPLICATIONS

This application is based upon and claims priority to U.S. Provisional Patent Application No. 61/112,504, entitled “Low-Energy Pulsed Electric Field Treatment Of Wine Grapes For Improved Juice Extraction Using Nanosecond To Microsecond Pulses,” filed Nov. 7, 2008, attorney docket number 028080-0418. The entire content of this application is incorporated herein by reference.

### BACKGROUND

1. Technical Field

This disclosure relates to making wine and other juices, including enhancing the quantity and quality of the juice.

2. Description of Related Art

Food, such as grapes, may be crushed (must) and pressed to extract juice.

Methods have been proposed for increasing the amount of juice which may be realized from pressing, such as chemical treatment. However, these methods may fail to provide significant additional juice and/or may result in poorer juice quality.

Post-electric fields have been proposed to be applied to wine grapes, such as is proposed in PCT Publication WO/2005093037, entitled “Improved and More Gentle Process for Extracting Useful Substances From Grapes, Grape Must Extracted Therefrom and Wine Produced Therefrom, As Well As Device for Carrying Out Electroporation.” However, systems of this type may cause the juice to be heated, which may adversely affect its quality, may cause a brown color in the juice, may be a time consuming process, and/or may require costly equipment.

### SUMMARY

An apparatus for treating food must may include a food must chamber configured to apply an electric pulse to the food must in a manner that causes an electric field to be generated within the food must. A pulse generator may be configured to deliver an electric pulse to the chamber that has a pulse width of between 10 and 100 nanoseconds. The chamber and the pulse generator may be configured such that they cause the electric field that is generated within the food must to be at least 1 kV/cm.

The chamber and the pulse generator may be configured such that they cause the electric field that is generated within the food must to be at least 10 or 20 kV/cm.

The chamber and the pulse generator may be configured such that they cause the electric field that is generated within the food must to be no more than 30 kV/cm.

The pulse generator may be configured to generate a pulse that is substantially unipolar, rectangular, triangular, or a fractional cycle of a sinusoid.

The pulse generator may be configured to deliver a series of pulses to the chamber. The series of pulses may have a frequency of at least 1 kHz.

The chamber and the pulse generator may be configured to transfer no more than 10 Joules, 1 Joule, or 100 milli-Joules to each gram of must.

The chamber may include a set of substantially parallel electrodes configured to apply the pulse across a volume of the food must.

The chamber may include sets of substantially parallel electrodes, each configured to apply a pulse across the same volume of the food must and to cause an electric field to be generated within the food must in a direction different from the field or fields generated by the other set or sets of substantially parallel electrodes. The pulse generator may be configured to deliver a pulse to each set of substantially parallel electrodes that has a pulse width of between 10 and 100 nanoseconds. The pulse generator may be configured to deliver the pulse to each set of substantially parallel electrodes substantially simultaneously.

An apparatus for treating food may include a food must chamber configured to apply an electric pulse to the food must in a manner that causes an electric field to be generated within the food must. A pulse generator may be configured to deliver a series of electric pulses to the chamber. The chamber and the pulse generator may be configured such that the series of pulses collectively transfer less than 10 Joules per gram of must.

An apparatus for treating food may be configured to treat food must.

These, as well as other components, steps, features, objects, benefits, and advantages, will now become clear from a review of the following detailed description of illustrative embodiments, the accompanying drawings, and the claims.

### BRIEF DESCRIPTION OF DRAWINGS

The drawings disclose illustrative embodiments. They do not set forth all embodiments. Other embodiments may be used in addition or instead. Details that may be apparent or unnecessary may be omitted to save space or for more effective illustration. Conversely, some embodiments may be practiced without all of the details that are disclosed. When the same numeral appears in different drawings, it refers to the same or like components or steps.

FIG. 1 illustrates an apparatus for treating food must.

FIG. 2 illustrates a food must chamber configured to apply an electric pulse to food must in a manner that causes an electric field to be generated within the food must.

FIG. 3 illustrates a cut-away view of the food must chamber illustrated in FIG. 2a taken along the line 3-3′.

FIG. 4 illustrates a pulse generator connected to a load presented by food must.

FIG. 5 illustrates another pulse generator connected to a load presented by food must.

FIG. 6 illustrate the voltage waveform of a pulse generated by the pulse generator illustrated in FIG. 4 when connected to the load presented by food must.

FIG. 7 illustrates a charging circuit that may be used in connection with the pulse generator illustrated in FIG. 5.

### DETAILED DESCRIPTION OF ILLUSTRATIVE EMBODIMENTS

Illustrative embodiments are now discussed. Other embodiments may be used in addition or instead. Details that may be apparent or unnecessary may be omitted to save space or for a more effective presentation. Conversely, some embodiments may be practiced without all of the details that are disclosed.

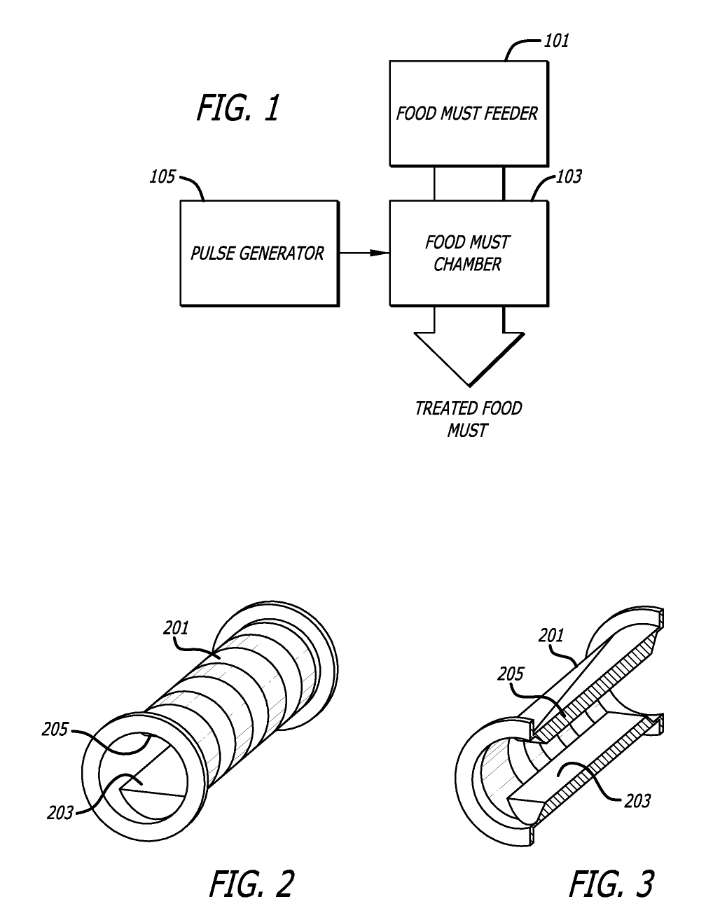

FIG. 1 illustrates an apparatus for treating food must. Among the food musts which the apparatus may be used to treat are fruit musts, such as grape must.

As illustrated in FIG. 1, the apparatus for treating food must may include a food must feeder 101, a food must chamber 103, and a pulse generator 105.

The food must feeder 101 may be configured to feed food must into the food must chamber 103. The food must feeder 101 may be configured to cause a steady flow of food must through the food must chamber. Alternatively, the food must feeder 101 may be configured to cause a certain volume of food must to be delivered into the food must chamber, to allow that volume to remain within the food must chamber for a period, and to deliver successive volumes into the food must chamber 103, each similarly being allowed to remain within the food must chamber 103 for a period.

Any type of device may be used for the food must feeder 101. For example, the food must feeder 101 may include one or more pumps, valves, and/or delivery tubing.

The food must chamber 103 may be configured to apply an electric pulse to food must which is within the chamber. The food must chamber 103 may be configured so as to apply the electric pulse to the food must in a manner which causes an electric field to be generated within the food must.

The food must chamber 103 may be of any type and may have any configuration. The pulse generator 105 may be configured to deliver an electric pulse to the food must chamber 103. The pulse generator 105 may be configured to deliver an electric pulse which has a pulse width between 10 and 100 nanoseconds. The pulse generator 105 may be of any type or configuration.

The food must chamber 103 and the pulse generator 105 may be configured such as they cause the electric field that is within the food must chamber 103 to be at least 1 kV/cm, at least 10 kV/cm, or at least 20 kV/cm. The food must chamber 103 and the pulse generator 105 may be configured such that they cause the electric field that is generated within the food must that is within the food must chamber 103 to be no more than 30 kV/cm.

The pulse generator may be configured to generate a pulse having any wave shape. For example, the pulse generator may be configured to generate a pulse that is substantially unipolar, bipolar, or otherwise. The pulse generator 105 may be configured to generate a pulse that is substantially rectangular, substantially triangular, or fractional cycles of sinusoids.

The pulse generator 105 may be configured to deliver series of pulses to the food must chamber 103. The pulses may have a frequency of at least one kilohertz.

The food must chamber 103 and the pulse generator 105 may be configured to transfer no more than 10 Joules to each gram of food must that is within the food must chamber. In other configurations, the food must chamber 103 and the pulse generator 105 may be configured to transfer no more than one Joule to each gram of food must within the food must chamber 103. In still other configurations, the food must chamber 103 and the pulse generator 105 may be configured to transfer at no more than 100 milli-Joules to each gram of must that is within the food must chamber 103.

FIG. 2 illustrates a food must chamber configured to apply an electric pulse to food must in a manner that causes an electric field to be generated within the food must. FIG. 3 illustrates a cut-away view of the food must chamber illustrated in FIG. 2a taken along the line 3-3′.

As illustrated in FIGS. 2 and 3, the food must chamber may include a cylindrical housing 201 that may contain a set of substantially parallel electrodes 203 and 205. As illustrated in FIG. 3, the substantially parallel electrodes 203 and 205 may be configured to apply an electric pulse across a volume of food must that is channeled within the food must chamber and thus that lies between them.

The food must chamber may include sets of substantially parallel electrodes. Each set may be configured to apply a pulse across the same volume of the food must as the other sets. Each set of substantially parallel electrodes may be oriented in a fashion that is different from the other sets of substantially parallel electrodes, thereby causing an electric field to be generated within the food must in a direction that is different from the direction of the fields generated by the other sets of substantially parallel electrodes. When sets of substantially parallel electrodes are used, the pulse generator 105 may be configured to deliver a pulse to each set of substantially parallel electrodes. Each pulse may have a width of between 10 and 100 nanoseconds. The electrical pulse generator 105 may be configured to deliver each pulse to each set of substantially parallel electrodes substantially simultaneously.

The electrodes 203 may be made of any type of electrically-conductive material, such as type 316 stainless steel. As illustrated in FIG. 3, the electrodes 205 may be mounted inside of the cylindrical housing 201

The cylindrical housing 201 may be inserted in series with tubing that is used by a winery to pump must from a crusher to a press. A pump may be configured to create enough pressure so that the must flows through the cylindrical housing 201. the must may be subjected to an electric field when it passes between the electrodes 203.

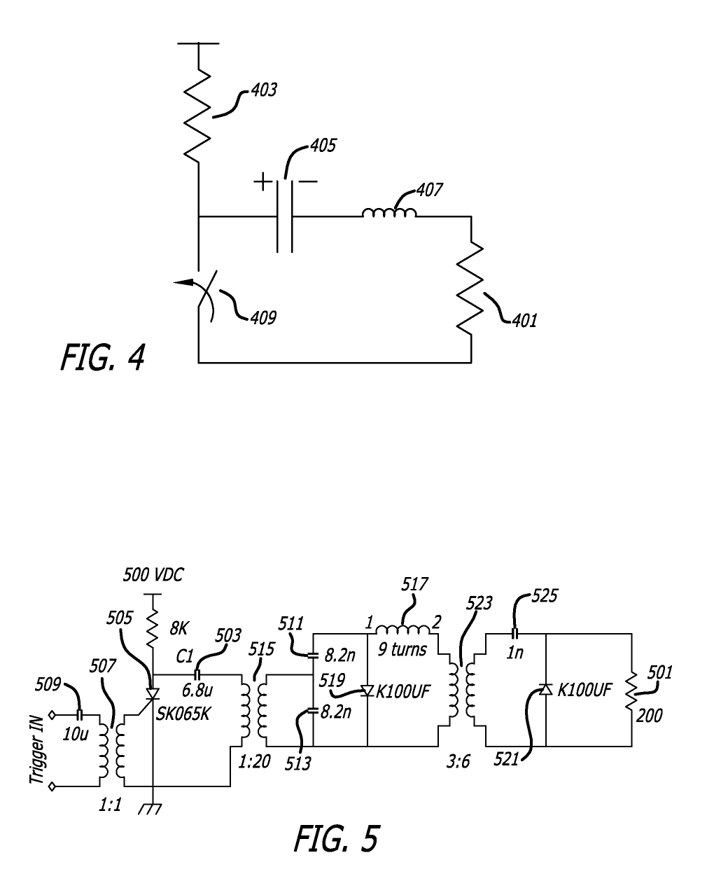

FIG. 4 illustrates a pulse generator connected to a load presented by food must.

As illustrated in FIG. 4, the food must may be represented by a resistive load 401 which is driven by a series RLC discharge circuit which may include a resistor 403 connected to a voltage potential (not shown), a capacitance 405, and inductance 407, and a switch 409.

Any values for the components may be used to effectuate the different driving conditions. In one embodiment, the resistive load which represents the food must 401 may have a resistance of approximately 25 ohms, the capacitance 405 may have a value of approximately 50 nF, the inductance 407 may have an inductance of approximately 7.8 MμH and the switch 409 may be a pseudo spark switch.

The capacitance 405 may be made from a bank of Murata 40 kV rated ceramic capacitors. The inductance 407 may be an air core inductor which may be made by winding a 40 kV rated wire around a piece of plastic pipe. The pulse forming network may be configured such that the series RLC circuit is critically damped.

FIG. 5 illustrates another pulse generator connected to a load presented by food must.

The embodiment illustrated in FIG. 5 may be made of all solid-state components and may generate an amplitude up to 100 kV and a pulse width of between 10 and 20 ns using magnetic pulse compression to the food must load 501. The circuit illustrated in FIG. 5 may deliver pulses to the food must load 501 at repetition rates greater than 1 Kilohertz.

The SCR 505 may function as a solid state switch in the circuit illustrated in FIG. 5. A gas switch may be used instead.

The amplitude of the pulse generated by the circuit illustrated in FIG. 5 may be scalable, while maintaining the pulse width, by adjusting the input voltage. For example, the amplitude may be scaled between 1 kV and 100 kV.

The pulse generator circuit may include a charging stage, the voltage doubling in magnetic compression stage, and a diode opening switch (DOS) stage.

In the charging stage, a DC power supply or resident charging circuit may be used to charge a capacitance 503 to 500 volts or less, which may store up to 850 mJ. An SCR triggering circuit, including the SCR 505, may consist of an 8:8 gate drive transformer 507 and capacitance 509 to protect the Trigger Capitol NIN supply from High Current Reflections. The SCR 505 may be turned on by applying a 5 volt, one microsecond TTL pulse across the gate and the cathode of the SCR 505. The energy stored in the capacitance 509 may be transferred across the saturable transformer 507 into the second stage, and the voltage may be increased by a factor of approximately 20.

As indicated, the second stage may consist of a voltage doubling in magnetic compression system. In the second stage, a capacitor voltage doubling mythology may be used to achieve higher output amplitudes, as compared to a Silicon opening switch (SOS) pulser. Capacitances 503 and 511 may be charged to 10 kV in parallel. When a transformer 515 saturates, the polarity of capacitance 503 may momentarily reverse in capacitance 503 and 511 may discharge in series through an inductance 517. The voltage polarity may be reversed and the amplitude may be doubled to approximately 20 kV. By operating with a lower voltage (e.g., greater than 350 volts) and a lower repetition rates (greater than 100 hertz), may be that no magnetic core reset may be required for the transformer 515, since the reverse current through the transformer 515 during operation may be sufficient to reset the core.

A diode 519 may consist of a set of diodes in series, such as a set of 3 diodes in series. Similarly, a diode 521 may consist of a set of diodes in series, such as a set of 8 diodes in series. Diode 519 may be replaced with a saturable magnetic core. The inductance 517 may be a nine-turn saturable inductor and may be used to compress the pulse width.

The third stage of the embodiment illustrated in FIG. 5 may include a transformer 523 which may be configured to double the voltage, and a diode operating switch (DOS) 521 which may be configured to sharpen the pulse and increase the amplitude. The transformer 523 may be configured to reverse the polarity of the pulse so that there may be no positive output pulse. The charge current of the capacitance 525 may pass through the diode 521 as forward bias. When the transformer 523 saturates, the capacitance 525 may discharge through the reverse-bias diode 521. When the current reaches a value close to a maximum, the energy may be transferred to the inductance of the secondary winding in the transformer 523. When the DOS 521 cuts off this current, a nanosecond pulse may be generated at the device output and delivered to the food must load 501.

Saturable inductors may be used as magnetic switches in the circuit. When so used, resetting the magnetic cores may become an important consideration. A saturable inductor may not properly function unless the core is in initially biased at the negative saturation flux on its b-h curve. This consideration may become more important as the repetition rate and charging voltage are increased. To reset the magnetic core, DC current may be passed through an auxiliary winding to reverse the magnetization field. A core reset circuit may be added to saturable transformer 515 for this purpose. The DC voltage supply in the core reset circuit may be supplied by a DC power supply that connects the back of the pulse generator to a wall outlet. The power supply may convert the wall voltage to 5.5 volts DC.

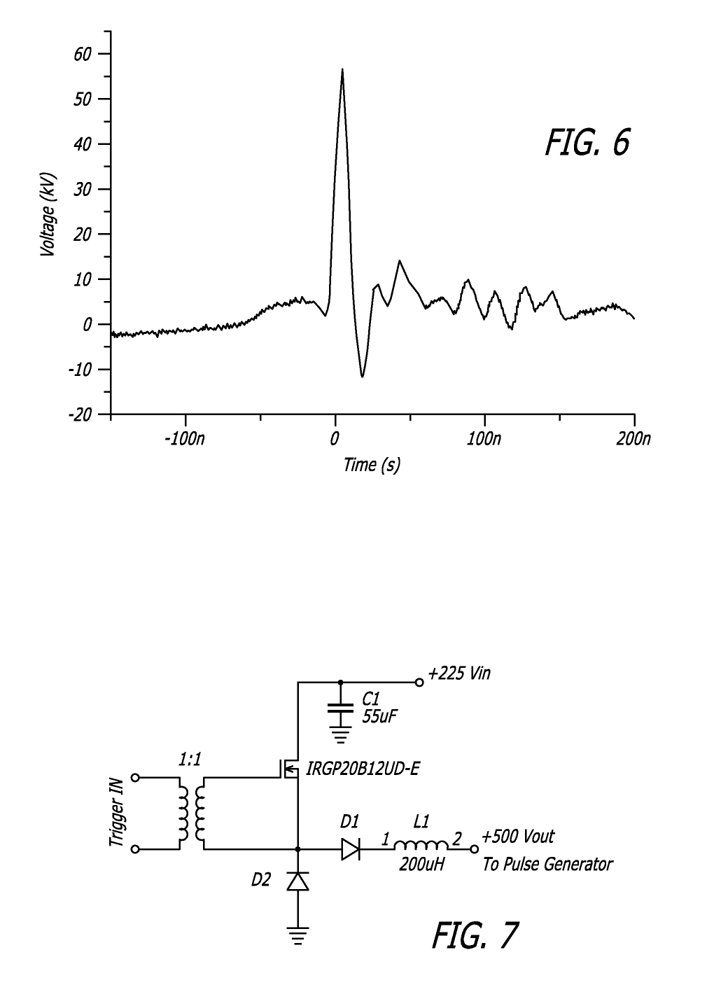

FIG. 6 illustrates the voltage waveform of a pulse generated by the pulse generator illustrated in FIG. 4 when connected to the load presented by food must.

FIG. 7 illustrates a charging circuit that may be used in connection with the pulse generator illustrated in FIG. 5.

This circuit may be connected in place of the 8 kohm resistor in FIG. 5. In this arrangement, the inductance (L1) in FIG. 7 may be directly connected to the capacitance 503 from FIG. 5.

This circuit may achieve a resonant transfer of energy between two capacitances: the 55 uF capacitance (C1) in FIG. 7 and the 6.8 uF capacitance C1 in FIG. 5. The 55 uF capacitance (C1) may be initially charged to a voltage of between 0 and 500 Volts. A 30 us trigger signal may be sent over a transformer to the IRGP20B12UD-E insulated gate bipolar transistor (IGBT), which may enable current to flow from C1 through the IGBT and the 200 uH inductance (L1). Diodes D1 and D2 may prevent energy from flowing backward in an undesirable direction.

The components, steps, features, objects, benefits and advantages that have been discussed are merely illustrative. None of them, nor the discussions relating to them, are intended to limit the scope of protection in any way. Numerous other embodiments are also contemplated. These include embodiments that have fewer, additional, and/or different components, steps, features, objects, benefits and advantages. These also include embodiments in which the components and/or steps are arranged and/or ordered differently.

The types of components, and their various combinations, may also be different.

For example, the a variety of devices other than the SCR 505 may be used for switch 505 shown in FIG. 5, such as one or more MOSFETs, IGBTs, thyristors, or gas discharge switches. The diodes 521 may be any of a variety of different types of diodes used for pulse generation, such as a silicon opening switch (SOS), step recovery diodes (SRD), drift step recovery diodes (DSRD), or junction recovery diodes. The diodes 521 may be replaced by saturating magnetic cores. The values of passive components, such as inductors, capacitors, and resistors, may be altered to achieve desired performance.

Unless otherwise stated, all measurements, values, ratings, positions, magnitudes, sizes, and other specifications that are set forth in this specification, including in the claims that follow, are approximate, not exact. They are intended to have a reasonable range that is consistent with the functions to which they relate and with what is customary in the art to which they pertain.

All articles, patents, patent applications, and other publications which have been cited in this disclosure are hereby incorporated herein by reference.

The phrase “means for” when used in a claim is intended to and should be interpreted to embrace the corresponding structures and materials that have been described and their equivalents. Similarly, the phrase “step for” when used in a claim embraces the corresponding acts that have been described and their equivalents. The absence of these phrases means that the claim is not intended to and should not be interpreted to be limited to any of the corresponding structures, materials, or acts or to their equivalents.

Nothing that has been stated or illustrated is intended or should be interpreted to cause a dedication of any component, step, feature, object, benefit, advantage, or equivalent to the public, regardless of whether it is recited in the claims.

The scope of protection is limited solely by the claims that now follow. That scope is intended and should be interpreted to be as broad as is consistent with the ordinary meaning of the language that is used in the claims when interpreted in light of this specification and the prosecution history that follows and to encompass all structural and functional equivalents.

The invention claimed is:

1. An apparatus for treating food must comprising:
a food must chamber configured to apply an electric pulse to the food must in a manner that causes an electric field to be generated within the food must; and
a pulse generator configured to deliver an electric pulse to the chamber that has a pulse width of between 10 and 100 nanoseconds,
wherein the chamber and the pulse generator are configured such that they cause the electric field that is generated within the food must to be at least 1 kV/cm.

2. The apparatus for treating food must of claim 1 wherein the chamber and the pulse generator are configured such that they cause the electric field that is generated within the food must to be at least 10 kV/cm.

3. The apparatus for treating food must of claim 2 wherein the chamber and the pulse generator are configured such that they cause the electric field that is generated within the food must to be at least 20 kV/cm.

4. The apparatus for treating food must of claim 1 wherein the chamber and the pulse generator are configured such that they cause the electric field that is generated within the food must to be no more than 30 kV/cm.

5. The apparatus for treating food must of claim 1 wherein the pulse generator is configured to generate a pulse that is substantially unipolar.

6. The apparatus for treating food must of claim 5 wherein the pulse generator is configured to generate a pulse that is substantially rectangular.

7. The apparatus for treating food must of claim 5 wherein the pulse generator is configured to generate a pulse that is substantially triangular.

8. The apparatus for treating food must of claim 5 wherein the pulse generator is configured to generate a pulse that is substantially a fractional cycle of a sinusoid.

9. The apparatus for treating food must of claim 1 wherein the pulse generator is configured to deliver a series of pulses to the chamber.

10. The apparatus for treating food must of claim 9 wherein the pulse generator is configured to deliver a series of pulses to the chamber having a frequency of at least 1 kHz.

11. The apparatus for treating food must of claim 1 wherein the chamber and the pulse generator are configured to transfer no more than 10 Joules to each gram of must.

12. The apparatus for treating food must of claim 11 wherein the chamber and the pulse generator are configured to transfer no more than 1 Joule to each gram of must.

13. The apparatus for treating food must of claim 12 wherein the chamber and the pulse generator are configured to transfer no more than 100 milli-Joules to each gram of must.

14. The apparatus for treating food must of claim 1 wherein the chamber includes a set of substantially parallel electrodes configured to apply the pulse across a volume of the food must.

15. The apparatus for treating food must of claim 14 wherein the chamber includes sets of substantially parallel electrodes, each configured to apply a pulse across the same volume of the food must and to cause an electric field to be generated within the food must in a direction different from the field or fields generated by the other set or sets of substantially parallel electrodes, and wherein the pulse generator is configured to deliver a pulse to each set of substantially parallel electrodes that has a pulse width of between 10 and 100 nanoseconds.

16. The apparatus of claim 15 wherein the pulse generator is configured to deliver the pulse to each set of substantially parallel electrodes substantially simultaneously.

17. The apparatus for treating food must of claim 1 wherein the food must is grape must and wherein:
the chamber is configured to apply the electric pulse to the grape must in a manner that causes the electric field to be generated within the grape must; and
the chamber and the pulse generator are configured such that they cause the electric field that is generated within the grape must to be at least 1 kV/cm.

18. An apparatus for treating food must comprising:
a food must chamber configured to apply an electric pulse to the food must in a manner that causes an electric field to be generated within the food must; and
a pulse generator configured to deliver a series of electric pulses to the chamber,
wherein the chamber and the pulse generator are configured such that the series of pulses collectively transfer less than 10 Joules per gram of must.

19. The apparatus of claim 18 wherein the food must is grape must and wherein:
the chamber is configured to apply the electric pulse to the grape must in a manner that causes an electric field to be generated within the grape must; and
the chamber and the pulse generator are configured such that the series of pulses collectively transfer less than 10 Joules per gram of grape must.
